(19) United States
(12) Patent Application Publication
(10) Pub. No.: US 2013/0216374 A1
(43) Pub. Date: Aug. 22, 2013

(54) FIXING APPARATUS FOR FAN

(71) Applicant: ZHENG-HENG SUN, Tu-Cheng (TW)

(72) Inventor: ZHENG-HENG SUN, Tu-Cheng (TW)

(73) Assignee: HON HAI PRECISION INDUSTRY CO., LTD., Tu-Cheng (TW)

(21) Appl. No.: 13/413,545

(22) Filed: Mar. 6, 2012

(30) Foreign Application Priority Data
Feb. 20, 2012 (CN) 201210038117.X

(51) Int. Cl. F01D 25/28; F16M 13/00

(52) U.S. Cl. 415/213.1; 248/674

(57) ABSTRACT

A fixing apparatus for a fan includes a bottom wall, and a fixing member for fixing the fan. The bottom wall forms a fixing portion and defines a fixing hole. The fixing member includes a plate defining a through hole, and a latch extending from a side of the board. The through hole includes a first hole and a second hole communicating with the first hole. The second hole is less than the first hole in size. A projection is formed on a distal end of the latch. The fixing member is slidably mounted to the bottom wall, and the fixing portion extends through the first hole and then engages in the second hole. The projection is engaged in the fixing hole.

### CROSS-REFERENCE OF RELATED APPLICATIONS

Relevant subject matter is disclosed in a pending U.S. patent application, titled “FIXING APPARATUS FOR FAN”, filed on Feb. 29, 2012, with the application Ser. No. 13/407,780, which is assigned to the same assignee as this patent application.

### BACKGROUND

1. Technical Field

The present disclosure relates to an apparatus for fixing a fan.

2. Description of Related Art

Large electronic devices use fans to cool electronic components. In related art, a fan is mounted in the electronic device by a plurality of screws, which makes it difficult and time-consuming to replace or remove the fan for repair.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of a first exemplary embodiment of a fixing apparatus together with a number of fans.

FIG. 2 is a partly assembled, isometric view of the fixing apparatus of FIG. 1.

FIG. 3 is an assembled, isometric view of the fixing apparatus of FIG. 1.

FIG. 4 is an assembled, isometric view of a second embodiment of a fixing apparatus together with fans.

FIG. 5 is an enlarged view of the circled portion V of FIG. 4.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

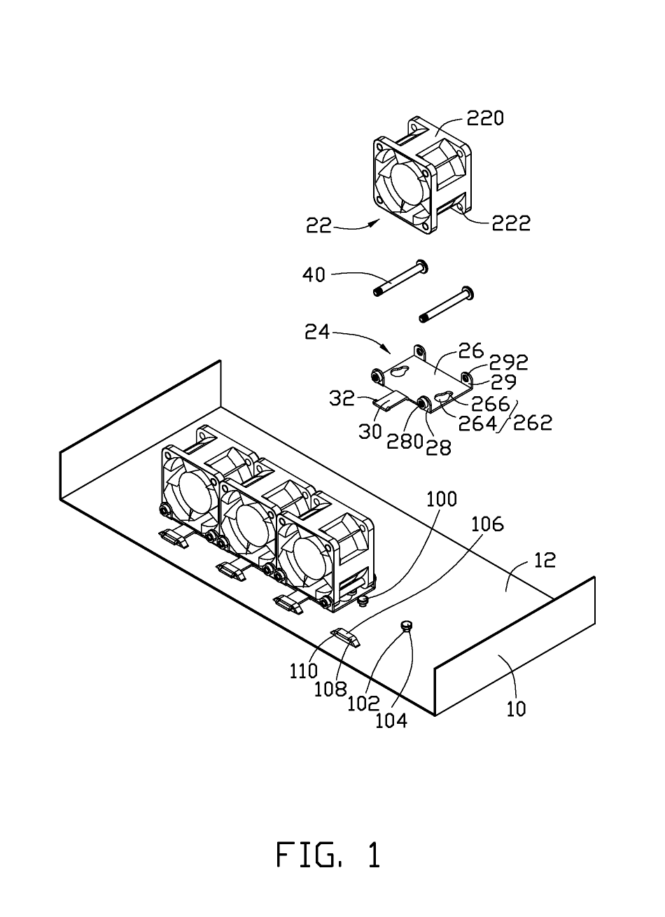

Referring to FIG. 1, a first embodiment of a fixing apparatus for a fan 22 includes a chassis 10 and a fixing member 24 detachably mounted in the chassis 10. The fan 22 has a flat front-facing surface and a flat rear-facing surface (together referred to as spaced boards 220). Each board 220 defines two corner holes 222 in a lower portion of the board 220.

The chassis 10 includes a bottom wall 12. Two fixing portions 100 are formed on the bottom wall 12. Each fixing portions 100 includes a neck 102 substantially perpendicularly extending up from the bottom wall 12, and a head 104 formed on a top end of the neck 102 opposite to the bottom wall 12. The diameter of the head 104 is substantially greater than the diameter of the neck 102. A blocking portion 106 is formed on the bottom wall 12, at a side of the fixing portions 100. In this embodiment, the blocking portion 106 includes a bridge-shaped blocking piece 108 formed on the bottom wall 12, and a fixing hole 110 defined between the blocking piece 108 and the bottom wall 12.

The fixing member 24 includes a rectangular plate 26, two first protrusions 28 extending up from a front side of the plate 26, two second protrusions 29 extending up from a rear side of the plate 26, and a latch 30 extending out from the front side of the plate 26. Two through holes 262 are defined in the plate 26. The distance between the two through holes 262 is substantially equal to the distance between the two fixing portions 100. Each through hole 262 includes a first hole 264 adjacent to the latch 30, and a second hole 266 communicating with the first hole 264 and further away from the latch 30. The size of the first hole 264 is greater than the size of the second hole 266. Each protrusion 28 defines a threaded hole 280. Each protrusion 29 defines a through hole 292. Two wedge-shaped projections 32 extend up from opposite sides of a distal end of the latch 30 opposite to the plate 26.

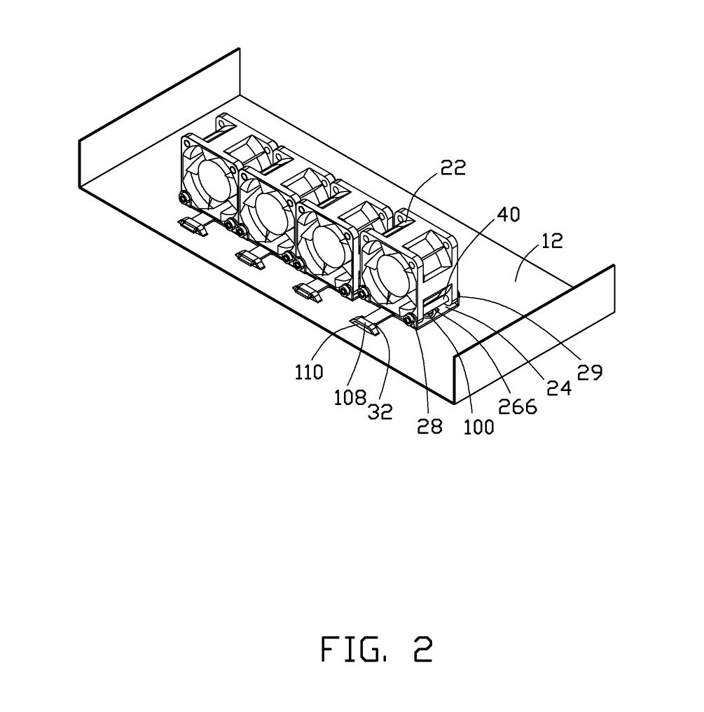

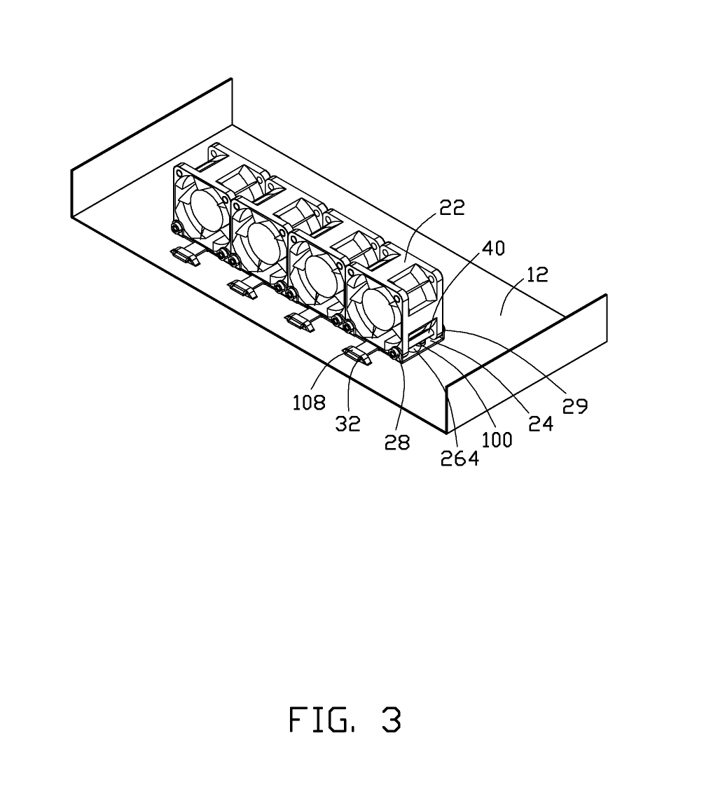

Referring to FIGS. 2 and 3, in assembling the fan 22 to the fixing member 24, the fan 22 is attached to the fixing member 24. The spaced boards 220 are supported on the plate 26. The lower portion of one of the boards 220 abuts against inner surfaces of the first protrusions 28, and the corner holes 222 are respectively aligned with the screw holes 280. The lower portion of the other one of the boards 220 abuts against inner surfaces of the second protrusions 29, and the corner holes 222 are respectively aligned with the through holes 292. Two fasteners 40 respectively extend through the through holes 292 and the corresponding through holes 222, and then are engaged in the corresponding threaded holes 280.

In installing the fixing member 24 to the chassis 10, the fixing member 24 is put on the bottom wall 12. The first holes 264 are manipulated over the fixing portions 100. The latch 30 are located at a rear side of the blocking piece 108 The fixing member 24 is then slid to allow the projections 32 to slidably abut the blocking piece 108, thereby deforming the latch 30 toward the bottom wall 12. After the projections 32 extending through the fixing hole 110, the latch 30 self-restore to make the projections 32 engage with a front side of the blocking piece 108 away from the fixing member 24. The necks 102 of the fixing portions 100 enter the second holes 266. The heads 122 of the fixing portions 100 abut the top surface of the plate 26 and are thus captive.

In uninstalling the fixing member 24 together with the fan 22, the latch 30 is deformed toward the bottom wall 12 with finger pressure, to disengage the projections 32 from the blocking piece 108. Therefore, the fixing member 24 together with the fan 22 can be slid back to disengage the first portions 100 from the second holes 266.

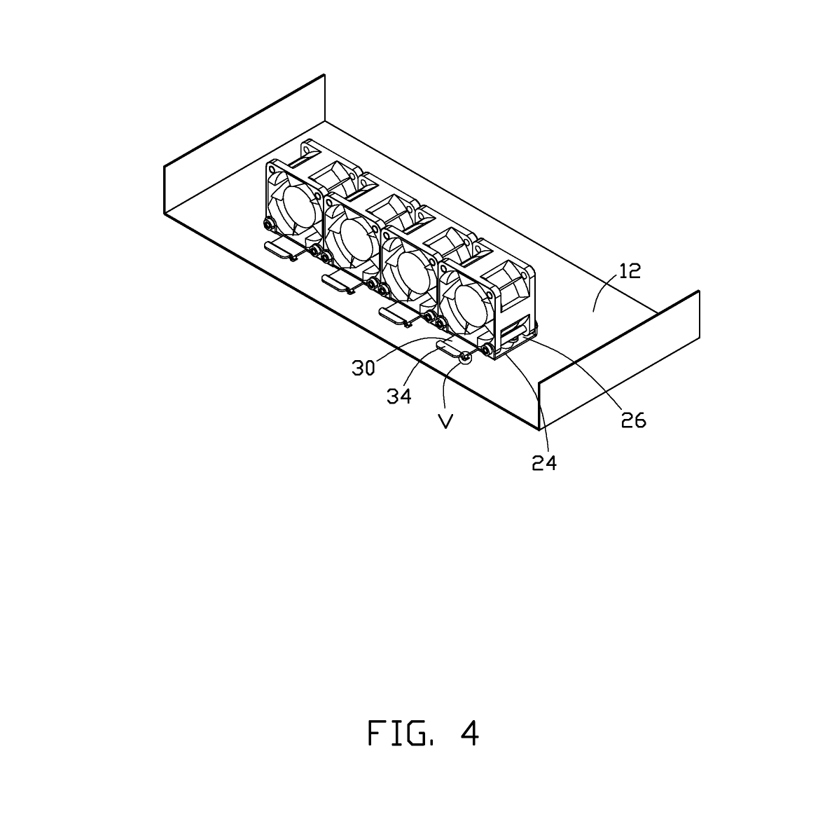

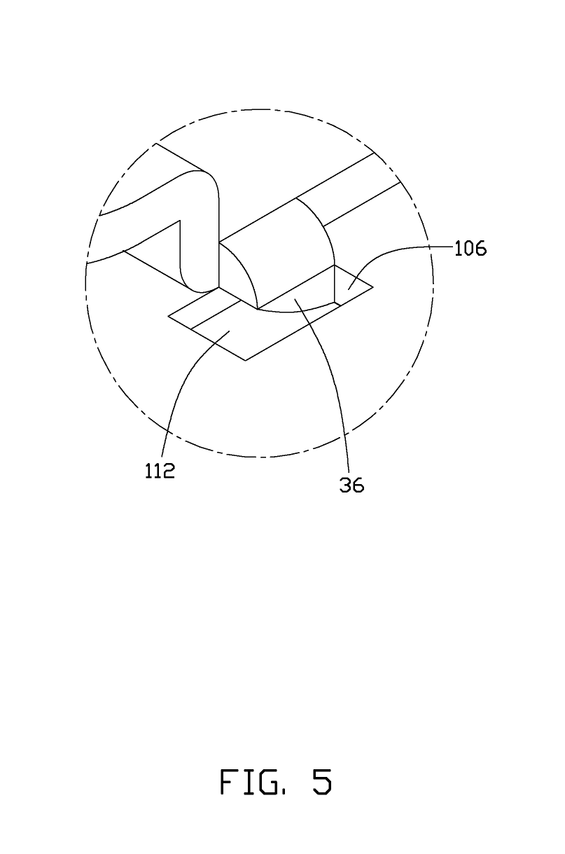

Referring to FIGS. 4 and 5, in a second embodiment, the blocking portion 106 includes two fixing holes 112 defined in the bottom wall 12. Two projections 36 extend down from opposite sides of a distal end of the latch 30 opposite to the plate 26. The fixing member 24 is slid toward the fixing hole 112 to allow the projections 36 to engage in the corresponding fixing holes 112 and abut a rear sidewall bounding the fixing hole 112. An operation portion 34 may extend up from the distal end of the latch 30 and then extend forward for conveniently operating the latch 30 to disengage the projections 36 from the corresponding fixing holes 112.

It is believed that the present embodiments and their advantages will be understood from the foregoing description, and various changes may be made thereto without departing from the spirit and scope of the description or sacrificing all of their material advantages, the examples hereinbefore described merely being exemplary embodiments.

What is claimed is:

1. A fixing apparatus for fixing a fan having two spaced boards, comprising:
a bottom wall forming a fixing portion and defining a fixing hole; and
a fixing member comprising a plate to fix the fan, and a latch extending out from a first side of the plate, the plate defining a first through hole having a first hole and a second hole communicating with the first hole, wherein a size of the first hole is greater than a size of the second hole; a projection is formed at a distal end of the latch opposite to the plate;
wherein the fixing member is slidably mounted on the bottom wall, the fixing portion is extended through the first hole and then engaged in the second hole, the projection extends through the fixing hole and engages with the bottom wall.

2. The fixing apparatus of claim 1, wherein the bottom wall further comprises a bridge-shaped blocking piece, the fixing hole is defined between the blocking piece and the bottom wall, the projection is wedge-shaped and extends up from the latch, the latch is deformable to extend through the fixing hole to allow the projection engaged with a side of the blocking piece away from the plate.

3. The fixing apparatus of claim 1, wherein the fixing hole is defined in the bottom wall, the projection is wedge-shaped and extends down from the latch to be engaged in the fixing hole.

4. The fixing apparatus of claim 1, further comprising two fasteners, wherein two first protrusions extend up from the first side of the plate, two second protrusions extend up from a second side of the plate opposite to the first side, each first protrusion defines a threaded hole, each second protrusion defines a second through hole, the fasteners respectively extend through the second through holes and the boards of the fan to engage in the corresponding threaded holes.

5. The fixing apparatus of claim 1, wherein the fixing portion comprises a neck extending from the bottom wall and a head extending from a top end of the neck opposite to the bottom wall, a diameter of the head is greater than a diameter of the neck, the head of the fixing portion is blocked by a top surface of the plate in response to the neck entering the second hole.

6. The fixing apparatus of claim 1, wherein the first hole is adjacent to the latch, the second hole is away from the latch.

7. A fan assembly, comprising:
a bottom wall forming a fixing portion and defining a fixing hole;
a fan; and
a fixing member comprising a plate fixing the fan, and a latch extending out from a first side of the plate, the plate defining a first through hole having a first hole and a second hole communicating with the first hole, wherein a size of the first hole is greater than a size of the second hole; a projection is formed at a distal end of the latch opposite to the plate;
wherein the fixing member is slidably mounted on the bottom wall, the fixing portion is extended through the first hole and then engaged in the second hole, the projection extends through the fixing hole and engages with the bottom wall.

8. The fan assembly of claim 7, wherein the bottom wall further comprises a bridge-shaped blocking piece, the fixing hole is defined between the blocking piece and the bottom wall, the projection is wedge-shaped and extends up from the latch, the latch is deformable to extend through the fixing hole to allow the projection engage with a side of the blocking piece away from the plate.

9. The fan assembly of claim 7, wherein the fixing hole is defined in the bottom wall, the projection is wedge-shaped and extends down from the latch to engage in the fixing hole.

10. The fan assembly of claim 7, further comprising two fasteners, wherein the fan comprises two opposite boards, each board defines two corner holes in a lower side of the board, two first protrusions extend up from the first side of the plate, two second protrusions extend up from a second side of the plate opposite to the first side, each first protrusion defines a threaded hole, each second protrusion defines a second through hole, the fasteners respectively extend through the second through holes, the corresponding corner holes to engage in the corresponding threaded holes.

11. The fan assembly of claim 7, wherein the fixing portion comprises a neck extending from the bottom wall and a head extending from a top end of the neck opposite to the bottom wall, a diameter of the head is greater than a diameter of the neck, the head of the fixing portion is blocked by a top surface of the plate in response to the neck entering the second hole.

12. The fan assembly of claim 7, wherein the first hole is adjacent to the latch, the second hole is away from the latch.
